(19) United States
(12) Patent Application Publication
(10) Pub. No.: US 2022/0145924 A1
(43) Pub. Date: May 12, 2022

(54) Torque Absorbing Surface

(71) Applicant: Victaulic Company, Easton, PA (US)

(72) Inventors: Matthew A. Bowman, Palmer, PA (US); Scott D. Madara, Nazareth, PA (US)

(21) Appl. No.: 17/510,698

(22) Filed: Oct. 26, 2021

Related U.S. Application Data
(60) Provisional application No. 63/112,194, filed on Nov. 11, 2020.

(51) Int. Cl. F16B 33/00; F16B 5/02

(52) U.S. Cl. CPC F16B 33/002; F16B 5/0241

(57) ABSTRACT

A plurality of raised surfaces on a platform absorb torque of a fastener contacting the surface while rotating relatively to the platform. Significant disproportionate increase in torque compared with the associated increase in bolt stress is observed by increased felt torque when tightening the fastener. Raised surfaces are used on lugs of a mechanical pipe coupling to increase the fastener's resistance to damage when powered tools are used to apply torque to the fastener.

### CROSS REFERENCE TO RELATED APPLICATIONS

This application is based upon and claims benefit of priority to U.S. Provisional Application No. 63/112,194, filed Nov. 11, 2020, which application is hereby incorporated by reference herein.

### FIELD OF THE INVENTION

This invention relates to surface features which engage rotating fastener elements.

### BACKGROUND

The increased use of powered tools in the field, particularly impact wrenches, allows relatively large torques to be applied to fasteners with little physical effort on the part of the technician. This confluence of factors has the potential to result in an increase in the rate of bolts being over-torqued, in some cases severely so, leading to damage when those bolts are over-torqued by technicians with high-output impact wrenches. It is therefore thought advantageous if measures could be taken which increase a bolt's resistance to damage when powered tools are used.

### SUMMARY

The invention concerns, in combination, a platform in contact with a fastener element, the fastener element being rotatable about an axis oriented transversely to the platform. In an example embodiment the platform comprises a base surface. A plurality of raised surfaces project transversely to the base surface for contacting the fastener element. Each raised surface comprises a plateau. Each raised surface is separated from at least an adjacent one of the raised surfaces by a channel positioned therebetween.

By way of example, the fastener element may comprise a threaded nut or a head of a threaded bolt.

In a specific example design, each plateau has a height of 0.060 inches above the base surface, and in practical designs each plateau may have a height ranging from 0.020 inches to 0.1 inches above the base surface. Further by way of example, each plateau has a minimum surface area of 0.010 square inches and in practical designs, each plateau may have a surface area ranging from 0.010 square inches to 0.1 square inches. In certain examples, each plateau has a minimum surface area ranging from 0.020 to 0.075 square inches.

In an example embodiment, at least one of the raised surfaces has a polygonal cross sectional shape. Further by way of example, at least one of the raised surfaces may have a round cross sectional shape. In a practical example embodiment, at least one of the raised surfaces is tapered, the at least one raised surface having a smaller perimeter at the plateau than at the base surface.

In an example embodiment the fastener element is softer than the plurality of raised surfaces. In a specific example, the fastener element may comprise steel and the plurality of raised surfaces may comprise ductile iron.

The invention further encompasses a coupling for joining pipe elements in end to end relation. In a particular example embodiment the coupling comprises a first segment having first and second ends oppositely disposed and a second segment having first and second ends oppositely disposed. A first fastener attaches the first end of the first segment to the first end of the second segment. A second fastener attaches the second end of the first segment to the second end of the second segment such that the segments surround a central space for receiving the pipe elements. First and second connection members are positioned respectively at each of the first and the second ends of each of the first and second segments. In an example embodiment, each connection member comprises a base surface oriented transversely to one of the fasteners. A plurality of raised surfaces project transversely to the base surface and are engageable with the one of the fasteners. Each raised surface comprises a plateau. Each raised surface is separated from at least an adjacent one of the raised surfaces by a channel positioned therebetween. By way of example, the fasteners may comprise a threaded nut engageable with one of the raised surfaces and/or a threaded bolt having a head engageable with one of the raised surfaces.

In a specific example design, each plateau has a height of 0.060 inches above the base surface, and in practical designs each plateau may have a height ranging from 0.020 inches to 0.1 inches above the base surface. Further by way of example, each plateau has a minimum surface area of 0.010 square inches and in practical designs, each plateau may have a surface area ranging from 0.010 square inches to 0.1 square inches. In certain examples, each plateau has a minimum surface area ranging from 0.020 to 0.075 square inches.

In an example embodiment, at least one of the raised surfaces has a polygonal cross sectional shape. Further by way of example, at least one of the raised surfaces may have a round cross sectional shape. In a practical example embodiment, at least one of the raised surfaces is tapered, the at least one raised surface having a smaller perimeter at the plateau than at the base surface.

In an example embodiment the fastener is softer than the plurality of raised surfaces. In a specific example, the fastener may comprise steel and the plurality of raised surfaces may comprise ductile iron. In an example embodiment, the plurality of raised surfaces may be integrally cast with the coupling.

The invention further includes a flange mountable on a pipe element. In an example embodiment the flange comprises a ring having a contact face adapted to interface with a mating flange, and an exposed face arranged oppositely to the contact face. By way of example the exposed face comprises a base surface and a plurality of raised surfaces projecting transversely to the base surface. Each raised surface comprises a plateau, and each raised surface is separated from at least an adjacent one of the raised surfaces by a channel positioned therebetween. In a practical example the plurality of raised surfaces extend around the entire exposed face.

In a specific example design, each plateau has a height of 0.060 inches above the base surface, and in practical designs each plateau may have a height ranging from 0.020 inches to 0.1 inches above the base surface. Further by way of example, each plateau has a minimum surface area of 0.010 square inches and in practical designs, each plateau may have a surface area ranging from 0.010 square inches to 0.1 square inches. In certain examples, each plateau has a minimum surface area ranging from 0.020 to 0.075 square inches.

In an example embodiment, at least one of the raised surfaces has a polygonal cross sectional shape. Further by way of example, at least one of the raised surfaces may have a round cross sectional shape. In a practical example embodiment, at least one of the raised surfaces is tapered, the at least one raised surface having a smaller perimeter at the plateau than at the base surface.

In an example embodiment the fastener is softer than the plurality of raised surfaces. In a specific example, the fastener may comprise steel and the plurality of raised surfaces may comprise ductile iron. In an example embodiment, the plurality of raised surfaces may be integrally cast with the flange.

The invention further encompasses a flange coupling for joining pipe elements. In an example embodiment the flange coupling comprises a first ring having a first contact face and a first exposed face oppositely disposed, and a second ring having a second contact face and a second exposed face oppositely disposed. The second contact face interfaces with the first contact face. A plurality of fasteners extend though the first and second rings. Each of the fasteners comprises at least one rotatable member engaging at least one of the exposed faces of one of the rings. In an example embodiment the at least one exposed face comprises a base surface. A plurality of raised surfaces project transversely to the base surface. Each raised surface comprises a plateau. Each raised surface is separated from at least an adjacent one of the raised surfaces by a channel positioned therebetween.

In an example embodiment the plurality of raised surfaces extend around the entire exposed face. Further by way of example, at least one of the raised surfaces has a polygonal cross sectional shape or a round cross sectional shape. In an example embodiment at least one of the raised surfaces is tapered, the at least one raised surface having a smaller perimeter at the plateau than at the base surface. By way of example, the rotatable member may comprise a threaded nut engageable with at least one of the raised surfaces and/or a threaded bolt having a head engageable with one of the raised surfaces.

In an example embodiment the rotatable member is softer than the plurality of raised surfaces. In a specific example embodiment the fastener may comprise steel and the plurality of raised surfaces may comprise ductile iron. In a specific example embodiment the plurality of raised surfaces are integrally cast with the at least one exposed face.

### BRIEF DESCRIPTION OF THE DRAWINGS

FIG. 1 is an isometric view of an example combination platform and fastener element according to the invention;

FIG. 1A is an isometric view of another example combination platform ad fastener element according to the invention;

FIG. 2 is an isometric view of a component of the example platform element shown in FIG. 1;

FIG. 3 is an isometric view of an example mechanical pipe coupling using a combination platform and fastener element according to the invention; and

FIG. 4 is an isometric view of an example flanged coupling using a combination platform and fastener element according to the invention.

### DETAILED DESCRIPTION

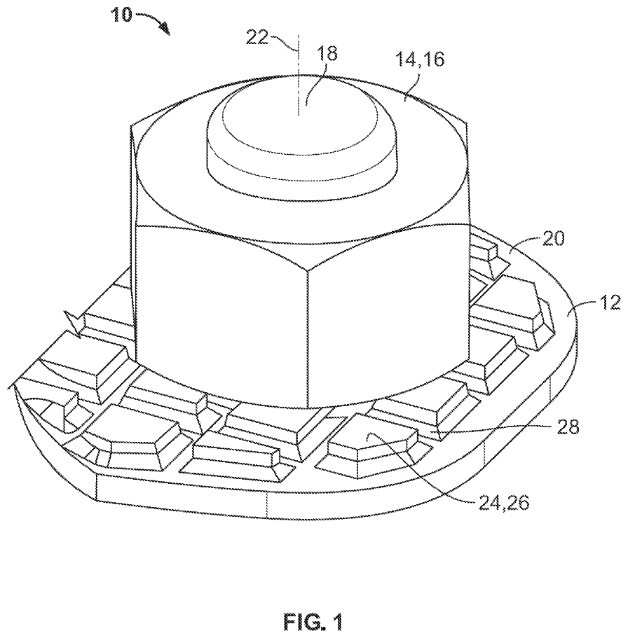

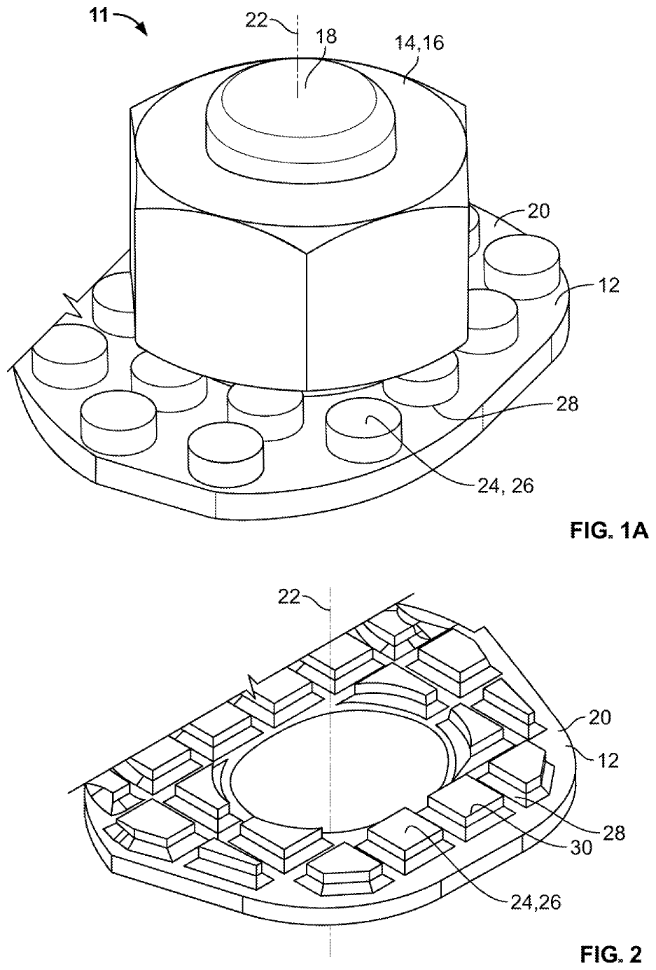

One aspect of the invention is directed to a combination platform and fastener element. An example combination 10 is shown in FIG. 1 and comprises a platform 12 in contact with a fastener element 14, in this example, a threaded nut 16 of a threaded bolt 18. Fastener element 14 could also comprise the head of the bolt 18 (not shown). As shown in isolation in FIG. 2, an example platform comprises a base surface 20. Base surface 20 is oriented transversely to an axis 22 about which the fastener element is rotatable. A plurality of raised surfaces 24 project transversely to the base surface 20. The raised surfaces 24 comprise respective plateaus 26. Each raised surface 26 is separated from at least one adjacent raised surface by a respective channel 28 positioned therebetween. The raised surfaces 24 in this example have polygonal cross sectional shapes, but other shapes are also feasible, as shown in FIG. 1A, wherein a practical example combination 11 of a platform 12 has raised surfaces 24 with plateaus 26 having round cross sectional shapes. As shown in FIG. 2, raised surfaces 24 may be tapered such that each raised surface has a smaller perimeter 30 at the plateau 26 than at the base surface 20. A taper angle of about 3° is advantageous to provide draft when the platform manufactured by a casting process.

As shown in FIGS. 1 and 1A, raised surfaces 24 contact the fastener element 14. In this example, the nut 16 bears forcibly against the plateaus 26 as it is rotated relatively to the platform 12 about axis 22, tightening the nut on to the fixed bolt 18. It is well known that tensile stress in the bolt 18 increases as the nut 16 is tightened, and that the torque required to turn the nut also increases as the nut is tightened. However, it is observed that when the rotating nut 16 forcibly contacts the raised surfaces 24, the torque required to turn the nut increases at a greater rate compared to the increase in bolt stress that would otherwise occur in the absence of the raised surfaces. This observed phenomenon is actually advantageous because it may be used to protect the bolt from damage due to over-torqueing.

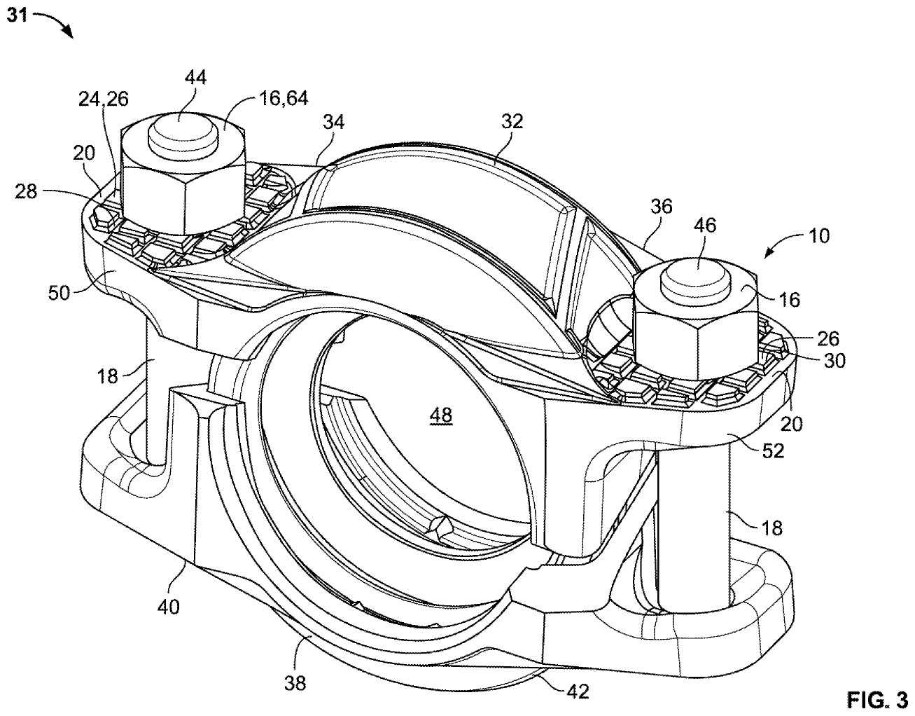

FIG. 3 illustrates a practical implementation of the combination 10 on a coupling 31 for joining pipe elements (not shown) in end to end relation. In this example the coupling 31 comprises a first segment 32 having respective first and second ends 34 and 36 oppositely disposed, and a second segment 38 having respective first and second ends 40 and 42 oppositely disposed. A first fastener 44 attaches the first end 34 of the first segment 32 to the first end 40 of the second segment 38. A second fastener 46 attaches the second end 36 of the first segment 32 to the second end 42 of the second segment 38 such that the segments 32 and 38 surround a central space 48 for receiving the pipe elements. In this example the fasteners 44 and 46 comprise mating nuts 16 and bolts 18.

First and second connection members 50 and 52 are positioned respectively at each of the first and the second ends (34, 36, 40, 42) of each of the first and second segments 32 and 38. In this example, each connection member 50, 52, comprises the above described base surface 20 oriented transversely to the respective fastener (44 or 46) which passes through the connection members. The raised surfaces 24 project transversely to each base surface 20 and are engageable with the fasteners 44 and 46. As described above with respect to combination 10, each raised surface 24 comprises a plateau 26, and each raised surface is separated from at least an adjacent one of the raised surfaces by a channel 28 positioned therebetween. Consistent with combination 10 described above and shown in FIG. 1, the raised surfaces 24 in this example have polygonal cross sectional shapes and are tapered such that each raised surface has a smaller perimeter 30 at its plateau 26 than at its base surface 20. In this example it is the nuts 16 which engage and rotate against the plateaus 26 of the raised features 24 when the fasteners 44 and 46 are tightened, however, in other example embodiments it may be the heads of the bolts 18 which engage and rotate against the plateaus. Although combination 10 is depicted used with the coupling 31, the combination 11 of FIG. 1A, having plateaus 26 with round cross sectional shapes, is also feasible in this implementation.

In a practical example of a coupling 31, significant disproportionate increase in torque compared with the associated increase in bolt stress was observed for plateaus 26 having a height of 0.060 inches above the base surface 20 and a minimum surface area of 0.010 square inches, when used with a standard ASME B18.2.2 heavy hex nut of size ½″, made of ASTM A563 carbon steel. For an effective design it is expected that plateau area will generally increase with increasing bearing area of the nut and or bolt, as fastener size increases. For this design, the phenomenon of disproportionate increase in torque was observed directly by increased felt torque when a hand wrench was used to tighten the coupling fasteners. In a test intended to induce bolt failure, when an impact wrench was used it was observed that the time to bolt failure increased by a factor of two when couplings employing the raised features according to the invention were tested against couplings not having the combination 10.

It is expected that effective designs of combinations 10 and 11 according to the invention may be achieved with plateaus 26 having a height above the base surface 20 ranging from 0.020 inches to 0.1 inches, with heights of 0.060 inches expected to be advantageous. Practical designs may also have surface areas ranging from 0.010 square inches to 0.1 square inches, with surface areas ranging from 0.020-0.075 square inches expected to be advantageous. Effective protection of bolts ranging from 0.25 inches to 1 inch in diameter (as well as similar and equivalent metric sizes) is expected to be achieved using combinations such as 10 and 11 according to the invention.

In the example coupling 31, the fastener element 14 (the nut 16) was formed of carbon steel and has a lower surface hardness than the plurality of raised surfaces 24, which were integrally cast with the coupling and formed of ductile iron. It has been observed in the experimental coupling that as increasing torque is applied to the nuts 16, plateaus 26 have a sacrificial nature, and are worn down by nuts 16, with bolt stress increasing significantly after plateaus have been significantly worn down.

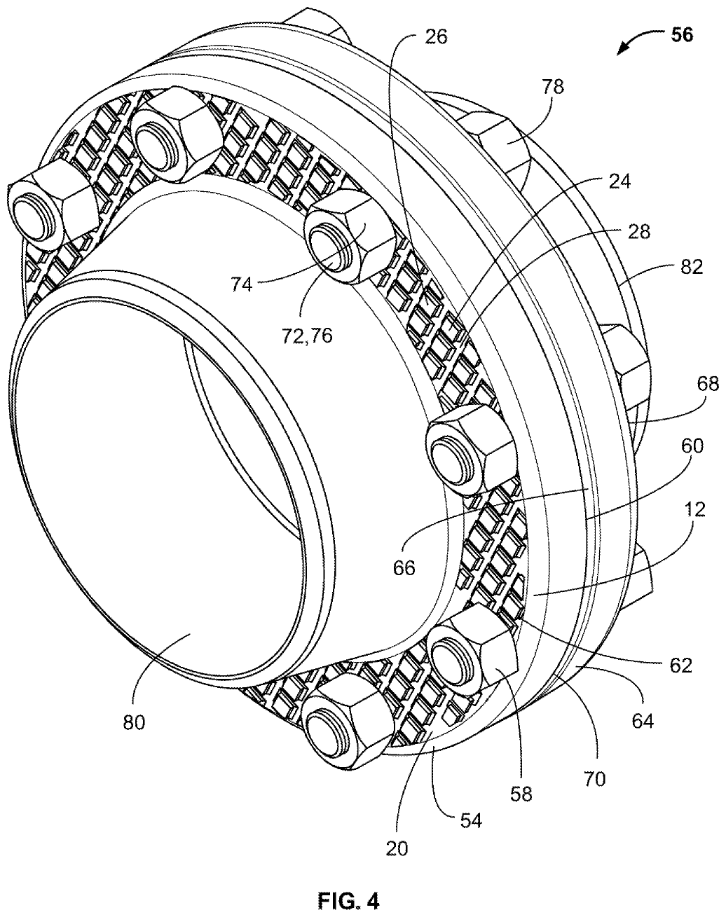

FIG. 4 shows another practical embodiment wherein the combination platform 12 and fastener elements are used on a flange 54 of a flange coupling 56. In this example, the flange coupling 56 comprises flanges 54 taking the form of a first ring 58, having a first contact face 60 and a first exposed face 62 oppositely disposed, and a second ring 64 having a second contact face 66 and a second exposed face 68 oppositely disposed. The second contact face 66 interfaces with said first contact face 60. Typically, a seal 70 is captured between the contact faces 60 and 66 to ensure a fluid tight joint.

A plurality of fasteners 72 extend though the first and second rings 58 and 64. Each fastener 72 comprises at least one rotatable member engaging at least one of the exposed faces 62, 68 of one of the rings 58, 66. In a practical example the rotatable member may comprise a threaded nut 74 or a threaded bolt 76 having a head 78 and may engage both exposed faces 62 and 68.

The exposed faces of the flanges 54 comprise a base surface 20 and a plurality of raised surfaces 24 projecting transversely to the base surface 20 as described above for the platform 12 and the coupling 31. The raised surfaces 24 comprise respective plateaus 26. Each raised surface 26 is separated from at least one adjacent raised surface by a respective channel 28 positioned therebetween. The raised surfaces 24 in this example have polygonal cross sectional shapes, but other shapes, such as the round shapes of FIG. 1A, are also feasible. Furthermore, it is advantageous if the raised surfaces 24 are tapered such that each raised surface has a smaller perimeter 30 at the plateau 26 than at the base surface 20. The raised surfaces 24 may have the same or similar height and area dimensions as described above. The raised surfaces may also comprise ductile iron and may be integrally cast with the flanges 54. As further described above, the fastener may be softer than the plurality of raised surfaces and may be formed of steel. Bolt stresses are expected to be limited until the plateaus are significantly worn down due to their sacrificial nature.

In the example shown in FIG. 4 the flange coupling 56 may comprise first and second pipe stubs 80 and 82 to which the rings 58 and 64 are respectively attached. The stub pipes 80 and 82 may be welded to respective pipe elements (not shown) cut or fabricated to a desired length, or the rings 58 and 64 may be attached directly to pipe stock, by welding for example.

In the flange coupling 56 the rotatable elements (threaded nuts 74 and/or bolt heads 78) engage and rotate relatively to and forcibly against the plateaus 26 when the coupling 56 is assembled. It is expected that the bolts 76 will experience the phenomenon of disproportionate increase in torque required to tighten the nut 74 or bolt head 78 as compared with the increase in tensile stresses within the bolt 76 upon tightening. This effect is expected to protect the bolt 76 from damage due to over-torqueing for the flange coupling 56.

What is claimed is:

1. In combination, a platform in contact with a fastener element, said fastener element being rotatable about an axis oriented transversely to said platform, said platform comprising:
a base surface;
a plurality of raised surfaces projecting transversely to said base surface for contacting said fastener element, each said raised surface comprising a plateau, each said raised surface separated from at least an adjacent one of said raised surfaces by a channel positioned therebetween.

2. The combination according to claim 1, wherein said fastener element comprises a threaded nut.

3. The combination according to claim 1, wherein said fastener element comprises a head of a threaded bolt.

4. The combination according to claim 1, wherein each said plateau has a height of 0.060 inches above said base surface.

5. The combination according to claim 1, wherein each said plateau has a height ranging from 0.020 inches to 0.1 inches above said base surface.

6. The combination according to claim 1, wherein each said plateau has a minimum surface area of 0.010 square inches.

7. The combination according to claim 1, wherein each said plateau has a surface area ranging from 0.010 square inches to 0.1 square inches.

8. The combination according to claim 1, wherein each said plateau has a minimum surface area ranging from 0.020 to 0.075 square inches.

9. The combination according to claim 1, wherein at least one of said raised surfaces has a polygonal cross sectional shape.

10. The combination according to claim 1, wherein at least one of said raised surfaces has a round cross sectional shape.

11. The combination according to claim 1, wherein at least one of said raised surfaces is tapered, said at least one raised surface having a smaller perimeter at said plateau than at said base surface.

12. The combination according to claim 1, wherein said fastener element is softer than said plurality of raised surfaces.

13. The combination according to claim 1, wherein said fastener element comprises steel.

14. The combination according to claim 1, wherein said plurality of raised surfaces comprise ductile iron.

15. A coupling for joining pipe elements in end to end relation, said coupling comprising:
a first segment having first and second ends oppositely disposed;
a second segment having first and second ends oppositely disposed;
a first fastener attaching said first end of said first segment to said first end of said second segment;
a second fastener attaching said second end of said first segment to said second end of said second segment such that said segments surround a central space for receiving said pipe elements;
first and second connection members positioned respectively at each of said first and said second ends of each of said first and second segments, each said connection member comprising:
a base surface oriented transversely to one of said fasteners;
a plurality of raised surfaces projecting transversely to said base surface and engageable with said one of said fasteners, each said raised surface comprising a plateau, each said raised surface separated from at least an adjacent one of said raised surfaces by a channel positioned therebetween.

16. The coupling according to claim 15, wherein at least one of said fasteners comprises a threaded nut engageable with one of said raised surfaces.

17. The coupling according to claim 15, wherein at least one of said fasteners comprises a threaded bolt having a head engageable with one of said raised surfaces.

18. The coupling according to claim 15, wherein each said plateau has a height of 0.060 inches above said base surface.

19. The coupling according to claim 15, wherein each said plateau has a height ranging from 0.020 inches to 0.1 inches above said base surface.

20. The coupling according to claim 15, wherein each said plateau has a minimum surface area of 0.010 square inches.

21. The coupling according to claim 15, wherein each said plateau has a surface area ranging from 0.010 square inches to 0.1 square inches.

22. The coupling according to claim 15, wherein at least one of said raised surfaces has a polygonal cross sectional shape.

23. The coupling according to claim 15, wherein at least one of said raised surfaces has a round cross sectional shape.

24. The coupling according to claim 15, wherein at least one of said raised surfaces is tapered, said at least one raised surface having a smaller perimeter at said plateau than at said base surface.

25. The coupling according to claim 15, wherein at least one of said fasteners is softer than said plurality of raised surfaces.

26. The coupling according to claim 15, wherein at least one of said fasteners comprises steel.

27. The coupling according to claim 15, wherein said plurality of raised surfaces comprise ductile iron.

28. The coupling according to claim 15, wherein said plurality of raised surfaces are integrally cast with said coupling.

29. A flange mountable on a pipe element, said flange comprising:
a ring having a contact face adapted to interface with a mating flange, and an exposed face arranged oppositely to said contact face, said exposed face comprising:
a base surface;
a plurality of raised surfaces projecting transversely to said base surface, each said raised surface comprising a plateau, each said raised surface separated from at least an adjacent one of said raised surfaces by a channel positioned therebetween.

30. The flange according to claim 29, wherein said plurality of raised surfaces extend around said entire exposed face.

31. The flange according to claim 29, wherein at least one of said raised surfaces has a polygonal cross sectional shape.

32. The flange according to claim 29, wherein at least one of said raised surfaces has a round cross sectional shape.

33. The flange according to claim 29, wherein at least one of said raised surfaces is tapered, said at least one raised surface having a smaller perimeter at said plateau than at said base surface.

34. The flange according to claim 29, wherein each said plateau has a height of 0.060 inches above said base surface.

35. The flange according to claim 29, wherein each said plateau has a height ranging from 0.020 inches to 0.1 inches above said base surface.

36. The flange according to claim 29, wherein each said plateau has a minimum surface area of 0.010 square inches.

37. The flange according to claim 29, wherein each said plateau has a surface area ranging from 0.010 square inches to 0.1 square inches.

38. A flange coupling for joining pipe elements, said flange coupling comprising:
a first ring having a first contact face and a first exposed face oppositely disposed;
a second ring having a second contact face and a second exposed face oppositely disposed, said second contact face interfacing with said first contact face;
a plurality of fasteners extending though said first and second rings, each of said fasteners comprising at least one rotatable member engaging at least one of said exposed faces of one of said rings, said at least one exposed face comprising:
a base surface;
a plurality of raised surfaces projecting transversely to said base surface, each said raised surface comprising a plateau, each said raised surface separated from at least an adjacent one of said raised surfaces by a channel positioned therebetween.

39. The flange coupling according to claim 38, wherein said plurality of raised surfaces extend around said entire exposed face.

40. The flange coupling according to claim 38, wherein at least one of said raised surfaces has a polygonal cross sectional shape.

41. The flange coupling according to claim 38, wherein at least one of said raised surfaces has a round cross sectional shape.

42. The flange coupling according to claim 38, wherein at least one of said raised surfaces is tapered, said at least one raised surface having a smaller perimeter at said plateau than at said base surface.

43. The flange coupling according to claim 38, wherein said at least one rotatable member comprises a threaded nut engageable with at least one of said raised surfaces.

44. The flange coupling according to claim 38, wherein said at least one rotatable member comprises a threaded bolt having a head engageable with one of said raised surfaces.

45. The flange coupling according to claim 38, wherein said at least one rotatable member is softer than said plurality of raised surfaces.

46. The flange coupling according to claim 38, wherein said at least one rotatable member comprises steel.

47. The flange coupling according to claim 38, wherein said plurality of raised surfaces comprise ductile iron.

48. The flange coupling according to claim 38, wherein said plurality of raised surfaces are integrally cast with said at least one exposed face.
